(19) United States
(12) Patent Application Publication
(10) Pub. No.: US 2025/0254410 A1
(43) Pub. Date: Aug. 7, 2025

(54) Coral Reef Monitoring Device and Method

(71) Applicant: Duquesne University of the Holy Spirit, Pittsburgh, PA (US)

(72) Inventors: Patrick M Juola, Pittsburgh, PA (US); Jessica Devlin, Pittsburgh, PA (US)

(73) Assignee: Duquesne University of the Holy Spirit, Pittsburgh, PA (US)

(21) Appl. No.: 18/964,281

(22) Filed: Nov. 29, 2024

Related U.S. Application Data
(60) Provisional application No. 63/603,899, filed on Nov. 29, 2023.

(51) Int. Cl. H04N 23/50; B63G 8/00; G06T 7/00; H04N 23/56; H04N 23/695

(52) U.S. Cl. CPC H04N 23/555; B63G 8/001; G06T 7/0016; H04N 23/56; H04N 23/695; B63G 2008/002; G06T 2207/20081; G06T 2207/20084

(57) ABSTRACT

The present invention is a specialized application of a system of GAN (“Generative Adversarial Network”) and image classifier technology in combination with automated or semi-automated submersible drones that can access coral reefs to photograph or image them, to capture the necessary data to prognose reef health. The present technology realizes for the first time that coral health analysis requires at least four-time element image collection—“past healthy coral;” “past compromised coral;” current status quo images from a first point in time of a reef to be monitored; and at least a second status quo image at a second point in time of the same reef. Critical to the method and device(s) of the invention is the use of a data augmentation tool to reach a “reasonably realistic” GAN-generated images of past healthy, past bleaching and past dead coral, together with prescribed standardized lighting protocols for reef photography.

### FIELD OF THE INVENTION

The present invention pertains to methods of monitoring, reporting, analyzing and “alarming” (a physical alert or alarm) the health and prognosis of coral reefs in the ocean, to enable both coral reef wellness intervention as well as essential data collection. The invention includes specialized modules.

### BACKGROUND OF THE INVENTION

The health of coral reefs is, or should be, of interest to everyone. Even apart from the undeniable self-interests of the living coral itself, and the microorganisms and wildlife that shelter in it, the status of a coral reef has come to be a harbinger of many things—pollution concerns, climate inquiries, ocean current tracking, and so much more. Sadly, for many of us, our individual experience of the health of a coral reef might be in observing its status as, “dead.” At that point, of course, any efforts to monitor or prognose the health of the reef would be futile, as dead coral cannot come back to life.

In general, three stages of coral reef viability are recognized: “healthy,” “bleaching,” and “dead.” “Bleaching” does not mean that a coral reef is dead. Healthy coral is often highly colored in multiple hues with vibrant, and varying, pigment patterns. By contrast, “bleaching,” according to the U.S. National Ocean Service, occurs when coral, under stress, expels its resident algae (zooxanthellae) and, in so doing, causes the coral to take on a lighter, or white, color. Relatively warmer water can cause such a stress, but increased water temperatures are not the only stresses that cause bleaching—various pollutants, physical concussions, and other interventions can also cause stress, for example. Corals can survive bleaching when it occurs, if the stressors are alleviated or at least partially reversed, but the bleaching itself does indicate vulnerability to mortality commensurate with its degree. With the understanding that coral and algae depend on one another for survival, it becomes apparent that any biologic stress on either the coral or the algae will threaten the viability of the reef, although not all algae are “good,” and invasive algae can populate a coral reef after the death of the coral.

Monitoring coral reefs requires addressing a myriad of hurdles. Depths and distances can pose challenges in reaching coral reefs, inasmuch as the reefs may be at distances from the shore line, or well below the ocean surface, making even getting to the coral a physical feat. Moreover, when “bleaching” is to be monitored, including the color changes and shifts involved in bleaching, light levels for observation become a critical factor—because the light level will govern what one sees and how one sees it (and that goes for photographs and imaging as well). Moreover, monitoring the health of a coral reef involves much more than considering any trends in actual bleaching. For example, a healthy coral reef will shelter all sorts of wildlife that, absent startling them, can be observed as to type and number, as indicators of healthy coral. Even the most careful of divers and snorkelers, unfortunately, tend to disturb this wildlife when swimming nearby, so for this reason coral monitoring should not be mounted by humans swimming nearby, when in any way possible. Images of physically undisturbed reefs will include the fauna as well as the microorganisms, whose presence and coloration will contribute to the images analyzed by the present GAN technology.

Accordingly, a need remains for a technology—automated or semi-automated—that can observe, record, assess, calculate and report the health of a coral reef, not only for data collection but to allow intervention (when at all possible) to save a reef under stress and in danger (such as with an audible or visible alarm). This remaining need is also for a specialized equipment module or modules.

### SUMMARY OF THE INVENTION

In order to meet this need, the present invention is a specialized application of a system of GAN (“Generative Adversarial Network”) technology in combination with automated or semi-automated submersible drones that can access coral reefs to photograph or image them, to capture the necessary data to prognose reef health over an inevitably irregular time pattern of data capture. The present technology realizes for the first time that coral health analysis requires at least four-time element image collection—“past healthy coral;” “past compromised coral;” current status quo images from a first point in time of a reef to be monitored; and at least a second status quo image at a second point in time of the same reef. In a second embodiment of the invention, the technology requires at least a five-time element image collection protocol for GAN analysis: “past healthy coral;” “past compromised coral;” and three sequential “recent status quo” images from a reef under surveillance taken at a first point in time and then again at at least a second and third point in time. In the five-time embodiment, a variation can be “past healthy coral,” “past compromised coral,” “past dead coral” and at least two time-intervalled images of the current reef under surveillance. Moreover, GAN analysis must be adjusted to standardized lighting, effected with sensors on the drone to assure equivalent lighting for every data capture, by deploying a strobe light with the camera wherein the strobe has an output of at least 30,000 lumens and which strobe is identically situated as to distance and angle every time the coral is photographed or imaged.

### DETAILED DESCRIPTION OF THE INVENTION

As described immediately above, the present invention is a specialized application of a system of GAN (“Generative Adversarial Network”) technology in combination with automated or semi-automated submersible drones that can access coral reefs to photograph or otherwise image them, to capture the needed data over an inevitably irregular time pattern. Among other aspects, the present technology deploys for the first time an at least four-time element image collection—“past healthy coral;” “past compromised coral;” current status quo images from a first point in time; and at least a second “current” set of status quo images at a second point in time. In a further embodiment of the invention, the technology requires at least five-time element image collection protocol for GAN analysis: “past healthy coral” (but not of the reef under surveillance); “past compromised coral” (but not of the reef under surveillance); and (at least) three “recent status quo images” from a reef under surveillance at (at least) three points in time, which three points in time will inevitably not be evenly spaced as to interim time elapsed (ocean surveillance is tricky, subject to weather, and must be mounted with flexibility as to auspicious days to venture into the waves). In the aforementioned five-time embodiment, a variation can be “past healthy coral,” “past compromised coral,” “past dead coral” and at least two time-intervalled images of the current reef under surveillance. Moreover, GAN analysis must be adjusted to standardized lighting, effected with sensors on the drone to assure equivalent lighting for every data capture, by deploying a strobe light with the camera and where the strobe has an output of at least 30,000 lumens and capability for consisting placement relative the coral reef, each time coral examination takes place.

Monitoring coral reefs according to the invention must be a dynamic undertaking, inevitably requiring consideration of data collected at irregular intervals and needing adjusted (standardized) light levels to compensate for light level variations in nature. Heretofore, GANs have been used in hybrid, predominantly static systems that generally compare images at two points in time. After a baseline photograph, for example, a diagnosis or assessment with a single later image can be effected: “Is there glaucoma evident today compared to baseline?;” “What will a single fall day look like based on this one summer image?;” or “What will this 24 year old look like as a 64 year old?” By contrast, an important aspect of the present invention is the inclusion of dynamic monitoring of a dynamic system, providing “time lapse” GAN analysis despite inevitably irregular data sampling, plus standardized light levels in underwater photography that have not been used to assess coral reefs in this way before.

In order to standardize lighting levels among images of coral reefs taken at different points in time and under different conditions, two lighting parameters must be observed in photographing each coral reef. First, since the coral reef will be subject to ambient sunlight and that light level will vary, it is important to overwhelm the ambient light by using at least one strobe light, mounted on the submersible drone in connection with the camera, for every image that is taken of the reef, and that strobe light must have an output of at least 30,000 lumens. Moreover, every time the submersible drone positions itself relative to a given reef, it must position the same strobe light in the exact same relative position (distance from) the reef, in order to assure standardized lighting, typically from a distance of no more than 5-10 feet away from the coral. All of this necessitates the use of positioning sensors on the submersible drone, as well as concomitant guidance accessories, together with the camera and at least one strobe light having the minimum 30,000 lumen output. It is not necessary that the same strobe light, in the same position, be used among different coral reefs—but the same strobe light, in the same position, must be used for data collection FOR EACH coral reef being monitored.

While known GANs (“Generative Adversarial Networks”) are already appreciated for being able to track and to monitor changes in graphics including photographs generally, the classical use of GANs has been to do things such as to generate realistic examples in single-point-in-time image-to-image translation tasks, such as translating photographs of summer to fall and winter, or to generate realistic representations that, while merely created, seem real. In other words, machine learning can be used to both track and project changes to generate believable transition images. The GANs do the work, but the GANs are not typically part of any sort of complex automated or semi-automated systems that monitor the health or prognosis of anything, let alone coral reefs.

As foreshadowed above with reference to glaucoma, at least some (medical) diagnostic applications for GANs were known prior to the present innovation, such as without limitation: Bisneto, Tomaz Ribeiro Viana; de Carvalho Filho, Antonio Oseas; Magalhães, Deborah Maria Vieira (February 2020). “Generative adversarial network and texture features applied to automatic glaucoma detection”. Applied Soft Computing. 90:106165. doi: 10.1016/j.asoc.2020.106165. However, the detection of the presence or absence of glaucoma is different from assessing trends and changes in coral reefs, particularly considering the additional challenges of accessing the reefs, collecting the data without disturbing the reef, correcting the lighting levels that nature would make variable without such intervention, and compiling and computing the necessary four-point or five-point data collection images identified above. Therefore, as far as anyone knows there has been no teaching or suggestion, in the prior art, of trying to develop a possibly automated or semi-automated health/viability assessment monitoring system for flagging and identifying vulnerable or at-risk coral reefs, as described herein. First, no one has suggested the deployment of drone cameras in such an oceangoing GAN monitoring system to anyone's knowledge—or the possible automated or semi-automated deployment of the drones and cameras with inevitably time-irregular download of the captured images. Likewise, no one has suggested the combined projection/retrospective image comparisons that are necessary when coral reef health is assessed in an ongoing fashion—necessitating the use of all of past healthy coral images, past vulnerable coral images, typically also past dead coral images, and at least two time-spaced “current” coral images for a specialized machine learning determination. In other words, the present technology requires monitoring the heretofore elusive “visual danger signs” of future coral damage yet-to-occur. As mentioned above, coral analysis therefore requires at least four time element image collection—“past healthy coral;” “past compromised coral;” current status quo images from a first point in time; and at least a second “current” set of status quo images at a second point in time, all analyzed (after data capture with controlled light levels) with GAN technology to assess and to prognose the health of the coral reef.

A key reason why the invention requires the above-described four-part or five-part approach is that the first two parts embody a critical dataset training step in the GAN deployment. Everyone already knows that coral reef images are prone to change over time—but until now no one knew what image changes from healthy to bleaching were significantly indicative of reef vulnerability, for further use to assess images changes as to other reefs. In other words, the present invention is not a deployment of standard GAN technology—instead the present inventors determined that by using a particular GAN data augmentation tool they can take and “train” a dataset of original and transformed images, to shift, rotate, darken, and desaturate the original images, to create an all-important augmented dataset. While tools to create augmented data sets are already known in the art, so are tools for using standard datasets and concatenated datasets, so the choice of generating and using an augmented dataset in the present invention provides the critically necessary, unique input for the GAN, so as to enhance the dataset while still preventing bias of the discriminator. The GAN thus learns from this sufficiently-large “training” dataset to produce reasonably realistic samples of coral, which is determined by the image classifier assessing them with greater than 80% average accuracy and confidence, as well as logging statistics of the GAN's performance throughout the run. Since the samples can be considered accurate by this measure, they then can be submitted to the classifier in a fresh instance to further train and enhance that model as if they were “new data”. So, using a GAN tool for training a dataset from past healthy and past bleaching (or past healthy, past bleaching and past dead) coral, a minimal dataset is elevated by means of data augmentation transformation and performance analysis, to verify that the transformations do not cause discriminator bias with the end goal of augmenting the image classifier. (A typical data augmentation GAN tool is currently commercially available as, “data_augment_tool.”) Stated more simply—in the practice of the present invention, “past healthy coral” and “past bleaching coral,” OR “past healthy coral,” “past bleaching coral and past dead coral” are all imaged and combined in a training set after using a GAN tool, known in the art, to generate an augmented dataset, after which the remainder of the method steps of the invention may be deployed.

The above-described previously available GAN tool for generating augmented data sets is not the only off-the-shelf GAN tool that can be encompassed within the various present method steps. StyleGAN, by NVIDIA, is just one of the existing GAN tools that can be used in the present invention, if the other described parameters are observed. Heretofore, StyleGAN has typically been used for the simple two-points in time projections, to show transformations such as a person's age or hair color, but like any other GAN tool in existence or after-acquired, it may be used in the practice of the invention as long as other constraints are observed. StyleGAN is not a data augmentation tool as discussed above.

The essence of the present method is the observance of the necessary algorithm, specific to coral monitoring, to train the GAN to the point at which it can produce “reasonably realistic” data. For the purpose of this algorithm, past healthy coral images are PH, past bleaching coral images are PB, and past dead coral images are PD, supplemented by the data augmentation tool AUG; whereas current reef images are C1, C2, and so forth. As with any GAN system, the Generator Model (GM) is responsible for output of the Generated Example (GE) so that the “Real Example” (RE, which in this case are either source images or source images processed by the data augmentation tool) data can be analyzed side-by-side with the Generated Example by the Discriminator D, to allow the discriminator to calculate the binary classifier to output whether the GE and RE are “real” or generated. Therefore, given the above abbreviations, the distinguishing algorithm for the present GAN monitoring and assessment of coral reefs is as follows, where X is a binary classification from the discriminator (determination of the image being a generated one as well as the accuracy of this determination):

$$Equation 1$$

$$D ( GE / RE ) = X where GE = GM ( R * X ( E 1 , E 2 , … , E \hat{} n ) ) where$$

$$R = Random points in latent space ( “ noise ” ) ,$$

$$E = A training epoc \text{} ( “ rounds ” of training ) with n being the number of epochs ;$$

$$RE = [ AUG ( PH / PB ) or AUG ( PH / PB / PD ) or ( C 1 , C 2 , … series ) ]$$

Once X has reached a “reasonable” degree of accuracy (>80% by the parameters of this invention), the GE can be accepted as valid training data for the classifier. For the second equation, an image classifier is trained to categorize images from a randomized input of either GE or RE (or C series data) from Equation 1. The images must be sorted into folders accurately identifying them by category in order for the classifier to learn from its incorrect determinations during training. In Equation 2, IC is the image classifier (in the original experiment, a Convolutional Neural Network model was used) and Y is the output or categorization of the classifier (categories being PH, PB or PD from the equation above). (C1, C2, . . . series) represents a series of images of coral captured in the wild, which can also be used to train IC as long as they are able to be accurately categorized as PH, PB, or PD with human intervention.

$$Equation 2$$

$$IC ( [ AUG ( PH / PB ) or AUG ( PH / PB / PD ) or ( C 1 , C 2 , … series ) or GE when X > 80 \% ] ) = Y$$

Once the Y in Equation 2 produces an average accuracy of >80%, it is considered to be sufficiently trained and able to determine the state of real examples. The formula to produce Y in Equation 2 is what would be used in time lapse analysis against images of coral that is being actively monitored. In the following equations, C1 is an image of coral (or coral reef) C captured at time T1 and C2 is an image of that same coral (under consistent framing conditions) captured at T2, which is any time after T1. The system of equations in Equation 3 can be used to evaluate change in categorization of that coral being monitored. With the understanding that (Y2−Y1) indicates any change in classification, the variable A would indicate that an alarm should be triggered in the appropriate systems for this subject C.

$$Equation 3$$

$$IC ( C 1 ) = Y 1 , IC ( C 2 ) = Y 2 where Y 1 and Y 2 is output of the image classifier with a metric of > 80 \% accuracy$$

$$( Y 2 - Y 1 ) / ( T 2 - T 1 ) = A where T 1 is the time at which image C 1 was captured and T 2 is the time at at which image C 2 was captured$$

Of course all coral reef images may, or may not, contain all possible colors as well as all possible fauna sheltering in and around the coral reefs—regardless of the stage of life of the coral in each image. At all points in imaging and processing, the ability to detect and process all colors is important, whether those colors are present in any given image or not.

The invention also includes the deployment of a submersible drone to take detailed images of coral to assess its health, without the need of human divers. A submersible drone is currently remotely-operated to navigate underwater and perform tasks. The remote-controlled operation may be automated (completely computer controlled) or semi-automated, that is, driven with partial manual control with otherwise computerized controllers for CPS positioning and spatial positioning relative to the reef being visited. Previous applications of submersible drones have been, for example, to identify and kill invasive Crown-of-Thorns starfish in an underwater setting. The benefit of remote-controlled submersible drones is not just a matter of convenience, because avoiding the presence of swimming personnel in the area of a coral reef is necessary to standardize conditions at the reef, in addition to avoiding the stress on the reef caused by having swimmers and divers nearby. The drones must be fitted with positioning and navigation software, known in the art, to make possible the consistent identical positioning adjacent to each reef as is required by this invention, to take the images or photographs for GAN analysis.

The present system is not just a research system, but is intended to be a dynamic system (and device) that not only tracks and prognoses coral reef health and viability, but can also sound an alarm or alert when a coral reef under surveillance has reached a critical point in bleaching that vulnerability to death is critical but intervention could still possibly save the reef. The alarm is triggered by pre-selected indices of A (see Equation 3) that indicate change in classification over time of coral being monitored. The device of the present method, therefore, includes: at least one submersible drone fitted with positioning and navigational devices; at least one remote control operator for the drone (optionally automated); at least one camera or imager on the drone; at least one strobe light with minimum 30,000 lumen output adjacent the camera or imager; telemetric, cable, or data-capture (card, drive, etc.) means to store images taken at the coral reef; GAN hardware and software, including a data augmentation tool, to train and analyze both existing coral images (healthy/bleaching/optionally dead) as well as current images captured by the submersible drone and its accessories; and at least one physical alarm (light, buzzer, bell, vibrator, etc.) that, when triggered by A, indicates vulnerability of one or more coral reefs under surveillance.

The invention is illustrated in the following examples.

### Example 1

It was our goal to best optimize the GAN to simulate coral images in various states of health & examine GAN behavior when trained on different modifications of the datasets. Our hypothesis was that if the image classifier categorizes GAN-generated images with >=80% accuracy and >=80% average confidence, then images could be considered “reasonably realistic.” We therefore conducted three experiments. First, we amassed a control dataset—original datasets showing coral images with 150-250 images per category (healthy/bleaching/dead). We then concatenated these original datasets to themselves (about 3,000 images per category, duplicates). We also, separately, augmented the original datasets using “data_augment_tool,” using Keras' ImageDataGenerator class (4,000-6,000 images, no duplicates). Using GAN analysis, surprisingly we were able to confirm that the augmented datasets allowed the GAN classifier to “guess” (a term of art in GAN analysis) with 83.33% accuracy and 86.46% average confidence as to the identify of a coral image as healthy, bleaching or dead, to be used in further GAN analysis of sequential images or photographs taken of other coral reefs.

### Example 2

Using the algorithm:

$$D ( GE / RE ) = X where GE = GM ( R * X ( E 1 , E 2 , … , E \hat{} n ) ) where$$

$$R = Random points in latent space ( “ noise ” ) ,$$

$$E = A training epoc \text{} ( “ rounds ” of training ) with n being the number of epochs ;$$

$$RE = [ AUG ( PH / PB ) or AUG ( PH / PB / PD ) or ( C 1 , C 2 , … series ) ]$$

$$IC ( [ AUG ( PH / PB ) or AUG ( PH / PB / PD ) or ( C 1 , C 2 , … series ) or GE when X > 80 \% ] ) = Y$$

$$IC ( C 1 ) = Y 1 , IC ( C 2 ) = Y 2 where Y 1 and Y 2 is output of the image classifier with a metric of > 80 \% accuracy$$

$$( Y 2 - Y 1 ) / ( T 2 - T 1 ) = A where T 1 is the time at which image C 1 was captured and T 2 is the time at at which image C 2 was captured$$

we analyze coral reef images C1 and C2 taken from a submersible drone from current coral reefs of interest to determine, as to any image C1 or C2 whether the images indicate healthy, bleaching, or dead coral, (formula for Y) which triggers an alarm based on a difference between Y1 and Y2 over time when C1 and C2 are used as input, respectively. The submersible drone is fitted with positioning and navigation software and hardware such that the drone, and imaging, is accomplished from the same orientation and distance from the reef each time, together with the use of a strobe light having at least a 30,000 lumen output to standardize the lighting of the reef between and among image captures. We claim:

1. A collection of one or more specialized equipment modules for monitoring coral health, with each said module comprising: at least one submersible drone; at least one strobe light mounted on said submersible drone outfitted with lighting having a minimum 30,000 lumens output and a regulable strobe duration and repetition; at least one camera adjacent to and associated with said strobe light; at least one positioning sensor for position said camera at a reproducible distance and angle from a surface of coral to be photographed; at least one timing device; at least one database; and at least one telemetry device; wherein each module may thus photograph for data capture, and compare underwater coral with standardized lighting and recorded time records for said data capture.

2. The collection of one or more specialized equipment modules according to claim 1, wherein said at least one database is pre-programmed with at least two images of a reference coral, with one image's being of healthy coral and a second image's being of compromised coral.

3. The collection of one or more specialized equipment modules according to claim 1, wherein said at least one database is pre-programmed with at least three images of a reference coral, with one image's being of healthy coral, with a second image's being of compromised coral, and with a third image's being of dead coral.

4. The collection of one or more specialized equipment modules according to claim 3, wherein said at least one database has the capacity to store at least two images taken of a coral reef to be monitored, with said at least two images' being taken at two different points in time and further wherein said images are time stamped by said timing device.

5. The collection of one or more specialized equipment modules according to claim 4 wherein said at least one database has the capacity to store at least three images taken of a coral reef to be monitored, with said at least three images' being taken at three different points in time and further wherein said images are time stamped by said timing device.

6. A device for monitoring the health of a coral reef, comprising: at least one submersible drone outfitted with positioning and navigational devices; at least one remote control operation device for said submersible drone; at least one camera or imager mounted on said submersible drone; at least one strobe light with minimum 30,000 lumen output positioned adjacent the camera or imager; telemetric, cable, or data-capture means to store images taken at the coral reef; GAN hardware and software, including a data augmentation tool, to train and analyze both previously collected coral images as well as current images captured by the submersible drone and its accessories; and at least one physical alarm that, when triggered by A according to the system of equations:
$$D ( GE / RE ) = X where GE = GM ( R * X ( E 1 , E 2 , … , E \hat{} n ) ) where$$
$$R = Random points in latent space ( “ noise ” ) ,$$
$$E = A training epoc \text{} ( “ rounds ” of training ) with n being the number of epochs ;$$
$$RE = [ AUG ( PH / PB ) or AUG ( PH / PB / PD ) or ( C 1 , C 2 , … series ) ]$$
$$IC ( [ AUG ( PH / PB ) or AUG ( PH / PB / PD ) or ( C 1 , C 2 , … series ) or GE when X > 80 \% ] ) = Y$$
$$IC ( C 1 ) = Y 1 , IC ( C 2 ) = Y 2 where Y 1 and Y 2 is output of the image classifier with a metric of > 80 \% accuracy$$
$$( Y 2 - Y 1 ) / ( T 2 - T 1 ) = A where T 1 is the time at which image C 1 was captured and T 2 is the time at at which image C 2 was captured$$
indicates vulnerability to death of one or more coral reefs under surveillance.
